(19) United States
(12) Patent Application Publication
(10) Pub. No.: US 2010/0042919 A1
(43) Pub. Date: Feb. 18, 2010

(54) WINDOWLESS CROSS PLATFORM PROGRAM, METHOD AND ENVIRONMENT

(75) Inventor: Frank Meyer, Milford, MI (US)

Correspondence Address: YOUNG BASILE, 3001 WEST BIG BEAVER ROAD, SUITE 624, TROY, MI, 48084, US

(73) Assignee: CREATIVE LIFESTYLES, Milford, MI (US)

(21) Appl. No.: 12/190,824

(22) Filed: Aug. 13, 2008

(51) Int. Cl. G06F 3/00

(52) U.S. Cl. 715/700

(57) ABSTRACT

A program and method for developing a computer program usable on a plurality of operating systems. User interface objects and output control interfaces are written in a windowless manner. Operating system specific libraries are provided for rendering objects to canvas, reading a user input, or hosting an object window. Operating system functions are abstracted as attributes which define how text and drawings are rendered.

### BACKGROUND

This invention relates to programs and methods for enabling a computer program to be platform independent or to be able to run on multiple operating systems,

A window-type computer program or application interacts with a user by displaying information in a window on a display screen or monitor. The user interacts with the program by an input device, such as a mouse or keyboard to enter information in the window. Thus, the window is the core user interface component for all computer operating systems. This, however, makes the porting of applications to different operating systems a very tedious and expensive process.

A programmer must know and understand each different operating system in detail so that the appropriate code can be written for each operating system. A software developer who creates computer application software which is to be used on different operating systems is required to program, debug and install a code in the application program suitable for each different operating system.

Thus, it would be desirable to provide a computer program and method which is capable of operating on multiple different operating systems, such as operating systems for Windows, Mac, Linux, etc., in which components are described and compiled in a manner that will run on all distinct operating systems while having the same look and feel on all operating systems.

### SUMMARY

A computer program and environment, on a computer usable medium, functionable on a plurality of operating systems includes means for providing user interface components as windowless components, means for defining software interface definitions including support for at least one of a keyboard input, a mouse input, a drop target input, a drop source input and a renderable object, and means for providing an operating specific library of at least one means for rendering objects to canvas and means for reading user inputs.

A method for developing a computer program functionable on a plurality of operating comprises the steps of:

providing user interface components as windowless components;

defining software interface definitions including support for at least one of a keyboard input a mouse input, a drop target input, a drop source input and a renderable object input; and

providing an operating specific library of at least one of rendering object outputs to canvas and reading user inputs.

### BRIEF DESCRIPTION OF THE DRAWING

The various features, advantages and other uses of the present invention will become more apparent by referring to the following detailed description and drawing in which:

FIG. 1 is a block diagram of a data processing system in which the present computer program and method can be used;

FIG. 2 is an example of a screen display of an application in the computer program and method;

FIG. 3 is a pictorial representation of optional user interface objects according to the computer program and method;

FIG. 4 is a pictorial representation of a host window function of the computer program and method; and

FIG. 5 depicts a pictorial example of windowless components, such as a scroll bar and a tab selection input according to the computer program and method.

### DETAILED DESCRIPTION

### Operating System

As used hereafter, an operating system or OS is software that manages computer resources and provides programmers/users with a means to access the resources. An operating system processes system data and user input and response by allocating and managing tasks and internal system resources as a service to users and programs using the system. An operating system performs basic tasks, such as controlling and allocating memory, prioritizing system requests, controlling input and output devices, facilitating computer networking, managing files, etc.

### Interface

An interface is also a definition of interaction between two software components, a piece of hardware, a hardware device, or a user.

### User Interface

User interface or human machine interface, as used hereafter, is the aggregate of means by which a person or user interacts with the computer system, a particular machine, device, or a computer program. The user interface provides an input means to allow the user to manipulate the system, and output to allow the system to produce and show the effects of the user's manipulation.

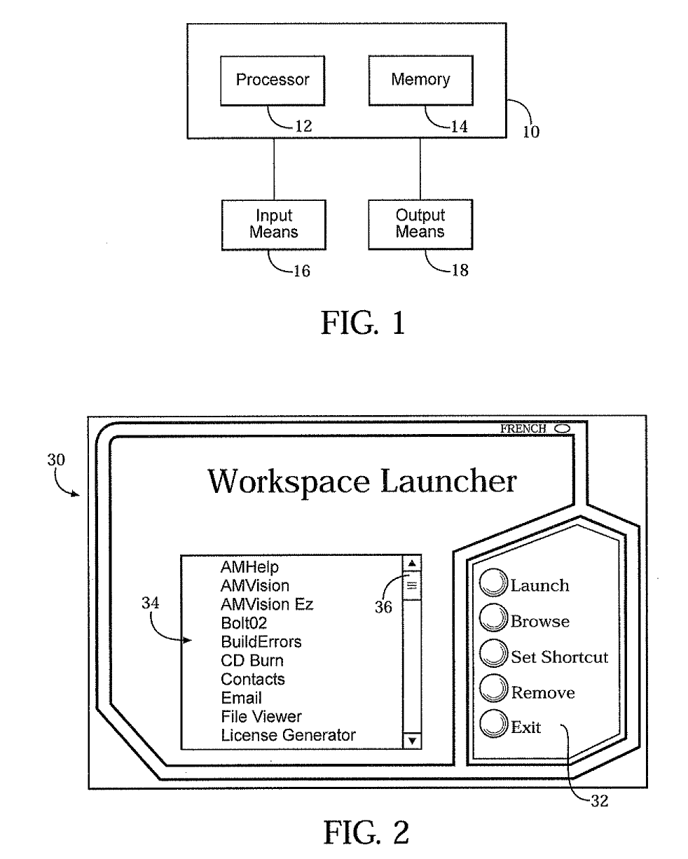

As shown in FIG. 1, a computer or data processing system 10 may employ the subject computer program and method. The system 10, by example only, includes a central processor 12 which may be, for example, a server, personal computer, work station or computer mainframe. The processor 12 communicates with a memory 14. The memory 14 can include both a volatile or non-volatile memory storage in various combinations for storing data and the executable program

Input means 16 are coupled to the processor 12. The input means 16 can include various data processing input devices, such as a keyboard, a mouse, a trackball, a light pen, a voice responsive device, and/or a touch sensitive device, as well as other pointing means.

Output or display means 16 are also coupled to the processor 12 and can include a display monitor and/or other output devices, such as printers, etc., for providing a visual display of program activities.

### User Interface Components

User interface components can include scroll bars, keyboard buttons, text input boxes, tab controls, trees, grids, etc. An example of an application using the present computer program and method is shown in a screen depiction 30 in FIG. 2. As shown on the right side of the screen, a series of buttons 32 are provided for user input. Each button 32 may be highlighted by a mouse controlled cursor or keyboard directional key, or otherwise highlighted or selected. On the left center of the screen depiction 30 is a tree control 34 which displays a list of items. The tree control or list 34 is controlled by a scroll bar 36 to allow scrolling through and selection of any item on the tree list 34.

In the present computer program, tool kit and method, each of the components depicted by the buttons 32 or on the tree list 34 is a windowless component which is written in a windowless manner and therefore will look and feel the same when used in multiple, distinct operating systems. A work space launcher is depicted in screen 30. It has a hostwindow which host the first windowless components which, in turn, can host other windowless components as shown in FIG. 4.

FIG. 5 depicts an example of a scrollbar user interface component and a tab control interface.

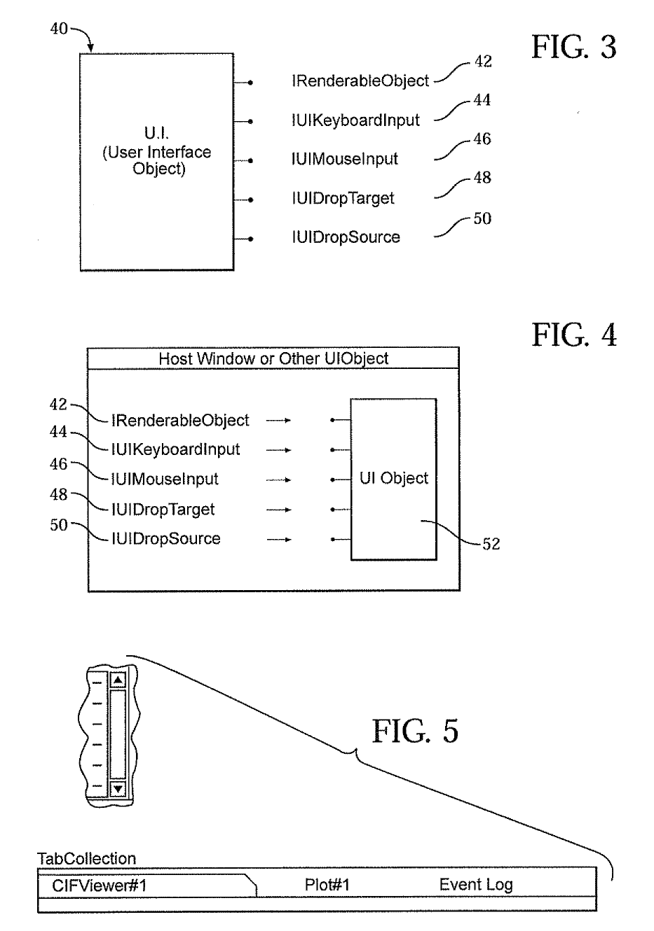

As shown in FIG. 3, the computer program and method includes user interface objects 40, each of the user interface objects supports various interfaces labeled IRenderablebject 42, IUIKeyboardInput 44, IUIMouseInput 46, IUIDropTarget 48, and IUIDropSource 50, many of which can be optional. As shown in FIG. 4, each user interface object 42, 44, 46, 48 and 50 can host one or more other user interface objects denoted generally by reference number 52. This keeps the design 40 of the computer program very modular. The computer program and method also controls the output means 18 by generic, cross platform, multiple operating systems usable output control interfaces. An output interface controls how to draw or render an object. The output interface is not a window, but rather an abstract canvas on which the first interface can draw. An input interface informs the object that there has been some input activity from the input means 16, such as from a mouse, keyboard, tab control, etc. The computer program and method contains a set of basic libraries that are operating system or OS specific dealing primarily with:

1. rendering to a canvas, and

2. reading user input,

3. hostwindows that hosts a first windowless component.

The hostwindow is the connection between the OS window and the windowless windows.

Based on these libraries, user interface components are provided which are common to all operating system scroll bars, tabs, controls, buttons, etc. This insures that user interface components will run on all operating systems.

The computer program and method also includes a mechanism for a component to request a redraw. This is achieved by one of two ways. First, the component can have the screen automatically refreshed at a given frequency. The program may only redraw areas that have changed from the last draw. Second, an event mechanism allows a user interface object to request a redraw.

If an object in the program wants to request a repaint, it can do this by firing an event. Event firing is achieved by a connection set up to that component from its parent.

In all cases, the computer program causes the component to render itself in an area of the canvas. A component may have child components and ask the child components to redraw themselves in the respective canvas area

IRenderableObject 42 is an interface that deals with how the object will be painted or drawn to the screen (or other device e.g., a printer). The method in this interface 42 is Render (CANVAS, RECT., . . . )” where the canvas is the place to paint and RECT is the area it is to paint itself.

IUIkeyboardInput 44 is an optional interface if keyboard input is required. This interface 44 is called when there is keyboard input. The method looks like “KeyPressed (long key, long AuxKey . . . ).”

IUIMouseInput 46 is another optional interface if a mouse input is required. The method looks like “Pointer (long buttons, long state, long AuxKey, double xpos, double yPos, RECT*, activeRect . . .)”

IUIDropSource 48 is an optional interface if the UI Object can provide a drag object. The method looks like “GetDropSource (Object, xPos, yPos . . . ).”

IUIDropTarget 50 is an optional interface that is called if the UI Object can receive dropped objects. The method looks like “DragDrop (pObject, Buttons, xPos, yPos, RECT . . . ).”

In the computer program, an OS specific library has an object “Host window” which provides the following interface: interface IHostWindow. The methods provided by this interface are:

put Object (Object) The Object is a windowless component which, in turn, has its own windowless component. See FIG. 4;

get Object (pObject);

Create(); and

Refresh (Immediately)

A windowless object which wants to request a repaint or a refresh uses a connection called “IUIRefreshEvent.” The method is: “void UIItemChanged(pItem . . . )” Hence, when a host window or UI windowless object hosts another windowless object, the host checks the hosted object to see if it wants to request refresh events. If so, the host object which implements the IUIRefreshEvent connects to the hosted object.

To achieve OS independent functionality, certain OS functions are abstracted. Examples include text rending, drawing file access, etc. For the case of text rendering as part of the OS independent program, two interfaces are provided:

1 interface IPMRenderStyle, which defines the attributes of a test display (similar to, but more extensive than Microsoft LOGFONT);

2. interface IPMRenderStyleEx,

Interface IPMRenderStyle includes the attributes which define how text will be rendered. It is just a description and not an actual implementation of rendering text. It has attributes such as:

font face;

font size (optional);

number display lines (optional);

text layout/alignment;

color;

back color (optional);

shadow offset;

shadow color;

boldness;

italics;

underline;

outline color;

outline width;

fit to fill text (optional).

Interface IPMRenderStyleEx implements the text rendering. It has methods such as:

Render(IPMRenderStyle, Text CANVAS, RECT . . . );

RenderHTML(IPMRenderStyle, Text, CANVAS, RECT . . . );

Typically a subset of the IPMRenderStyleEx needs to be implemented specific to each OS and will be part of the OS specific library.

Basic drawings which function similar to the text rendering can be abstracted. Alternately, use can be made of cross platform drawing libraries, e.g. openCaL.

### HostWindow Implementation

This is the connection to the specific OS. Its implementation is described in an Microsoft windows environment for clarity.
The create method:
A new window type using is registered
RegisterClass Ex (Microsoft function)
   This window has its own window message loop which is created using:
CreateWindow (Microsoft function).

The put Object method:
1. disconnects any existing object,
2. checks the new object for IUIDrop Target if it wants this, then call the Microsoft RegisterDragDrop (Microsoft function),
3. checks the new object to determine if it can fire events and, if so, then connects itself, e.g.,.CComQIPtr<IEventSource>pEventSource(pobject)
   if(pEventSource)
   pEventSource>Advise(GetUnknown)(), CONNECT)\

The event fire callback, “UTItemChanged ( . . . )”, for a refresh/redraw.

The standard windows message loop is redefined. Messages are dealt with as follows:
case WM_PAINT;
The object supports IRenderable object so it is called:
case WM_LBUTTONDOWN;
case WM_LBUTTONUP;
case WM_RBUTTONDOWN;
case WM_RBUTTONUP;
case WM_MOUSELEAVE:

If the object supports IUIMouseInput then it is called:

case WM_MOUSEMOVE:

If the move is with mouse down and exceeds an amount then if the object supports pUIDDropSource then call the Microsoft DoDragDrop:

Otherwise, if the object supports IUIMouseInput, then call it R-(case WM_CHAR: if an object supports IUIKeyboardInput, then call it. The method intercepts the drag drop calls to see if the area targets support IUIDropsource, if the area targets does provide support, then call it.

The disclosed computer program, toolkit and method enables a program developer to bypass the OS message loop. This is potentially advantageous when the developer wants higher speed and more determinacy as the developer can write software which can talk directly to the hardware, for example, in a Microsoft case, using their direct input interface. The present design also lends itself to the use of multiple concurrent input devices, e.g., more than one mouse or keyboard. One advantage of the disclosed computer program, toolkit and method is that by not using a windows environment, the user/engineer can easily switch on the fly what information is available to the display. This will be very fast compared to using a Windows operating system

What is claimed is:

1. A computer program, on a computer usable medium, functionable on a plurality of operating systems comprising:
means for providing user interface components as windowless components;
means for defining a software interface to support at least one of a keyboard input, a mouse input, a drop target input, a drop source input and a renderable object; and
means for providing an operating system specific library for at least one of rendering object outputs to canvas and reading user inputs.

2. The computer program of claim 1 further comprising:
means for each user interface object to host another interface object.

3. The computer program of claim 1 wherein:
the output control interfaces support at least one of a draw object; and inform on input activity from any one of the input means.

4. The computer program of claim 1 further comprising:
means for an object to at least one of request by repaint and to use a continual refresh mechanism.

5. The computer program of claim 4 wherein the means for requesting a repaint comprises:
means for abstracting at least one of a text rendering and a drawing.

6. The computer program of claim 5 wherein the at least one of a text rendering and a drawing further comprises attributes.

7. The computer program of claim 1 further comprising:
means for abstracting operating system functions.

8. The computer program of claim 7 wherein the means for abstracting operating system functions comprises:
means for providing operating system independent program interfaces.

9. The computer program of claim 8 wherein the interfaces comprise attributes defining how at least one of text and drawings will be rendered.

10. A method for developing a computer program functionable on a plurality of operating systems, the method comprising the steps of:
providing user interface components as windowless components;
defining user a software interface i for supporting at least one of a keyboard input, a mouse input a drop target input, a drop source input and a renderable object input; and
providing an operating system specific library of at least one of rendering object outputs to canvas and reading user inputs.

11. The method of claim 10 further comprising the step of:
enabling each user interface object to host another object internally.

12. The method of claim 10 wherein the step of providing the output control interfaces further comprises the step of:
supporting at least one of a draw object and informing on input activity from any one of input means.

13. The method of claim 10 further comprising the step of:
enabling an object to at least one of request a repaint and to use a continual refresh mechanism.

14. The method of claim 13 wherein the step of enabling an object to request a repaint comprises the step of:
enabling an object to abstract at least one of a text rendering and a drawing.

15. The method of claim 14 further comprising the step of:
providing attributes for at least one of the text rendering and the drawing.

16. The method of claim 10 further comprising the step of abstracting operating system functions.

17. The method of claim 16 wherein the step of abstracting comprises the step of:
providing operating system independent program interfaces.

18. The method of claim 17 further comprising the step of:
forming the interfaces with attributes defining how at least one of text and a drawing will be rendered.
